(19) United States
(12) Patent Application Publication
(10) Pub. No.: US 2021/0032408 A1
(43) Pub. Date: Feb. 4, 2021

(54) POLYSILOXANE RESIN, COATING COMPOSITION COMPRISING THE SAME, AND APPLICATION THEREOF

(71) Applicant: ETERNAL MATERIALS CO., LTD., Kaohsiung (TW)

(72) Inventors: SHENG-WEI LIN, KAOHSIUNG (TW); MAO-RONG YEH, KAOHSIUNG (TW); AN-KAI WU, KAOHSIUNG (TW); CHUN-HSIUNG CHANG, KAOHSIUNG (TW)

(73) Assignee: ETERNAL MATERIALS CO., LTD., KAOHSIUNG (TW)

(21) Appl. No.: 16/939,801

(22) Filed: Jul. 27, 2020

(30) Foreign Application Priority Data
Jul. 30, 2019 (TW) 108127092

(51) Int. Cl. C08G 77/04; C09D 183/04; C03C 17/30; C03C 17/00

(52) U.S. Cl. CPC C08G 77/04; C09D 183/04; C08K 3/36; C03C 17/009; C03C 17/30

(57) ABSTRACT

A polysiloxane resin, which includes a reaction product of the following:

(a) a non-linear polysiloxane oligomer having a C₁₋₃ alkoxy or a hydroxy group and a weight average molecular weight of about 500-6000;

(b) a linear polysiloxane oligomer of Formula (II):

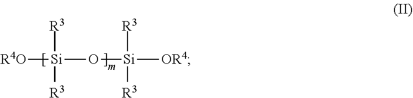

and

(c) a siloxane monomer,

wherein R³, R⁴, and m are as defined in the specification.

Also, a coating composition including the polysiloxane resin.

### BACKGROUND

### 1. Field of the Disclosure

The present disclosure relates to a polysiloxane resin, a coating composition comprising the polysiloxane resin, and application thereof.

### 2. Description of the Related Art

Polysiloxane resin has properties such as optical transparency, low thermal conductivity, low toxicity, electrical insulation, and chemical resistance, and is widely used in various fields as coating adhesive, etc.

Polysiloxane resin comprises silicon-oxygen bonds (—Si—O—) in the backbone and can be synthesized from various silicon-containing monomers and oligomers. By selecting the starting materials and controlling the structure (such as the degree of crosslinking or divergence) and molecular weight of the polysiloxane resin, polysiloxane resins of various properties can be provided, such as liquid silicone oil, flexible polysiloxane resin, and even rigid polysiloxane resin. However, the above properties often cannot be obtained at the same time. For example, polydimethylsiloxane (PDMS) is a linear polysiloxane resin having good flexibility, but the surface may be cracked when baked at high temperature or exposed to high temperature for a long time. Whereas, the polysiloxane resin with good rigidity is often not resistant to bending, and is likely to crack or fracture under stress.

Given this, various polysiloxane resins are continuously developed in the art to meet different needs.

### SUMMARY

The present disclosure provides a novel polysiloxane resin. The polysiloxane resin of the present disclosure has advantageous properties in terms of hardness, toughness, flexibility, bending resistance, weather resistance, heat resistance, and chemical resistance. Therefore, compared with the polysiloxane resins in the prior art the polysiloxane resin of the present disclosure is more suitable for use in various situations and provides convenience in application.

An object of the present disclosure is to provide a polysiloxane resin, which comprises a reaction product of the following:

(a) a non-linear polysiloxane oligomer (also referred to as “Oligomer A”) having a C₁₋₃ alkoxy group or a hydroxy group, and a weight average molecular weight of about 500-6000;

(b) a linear polysiloxane oligomer (also referred to as “Oligomer B”) of Formula (II):

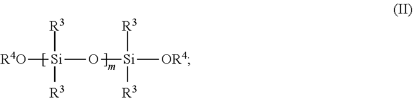

and

(c) a siloxane monomer,

where each R³ may be the same or different and is independently methyl or phenyl; each R⁴ may be the same or different and is independently H, methyl of ethyl; and m is an integer from 2 to 20.

Another object of the present disclosure is to provide a coating composition comprising the polysiloxane resin.

Another object of the present disclosure is to provide use of the above-mentioned polysiloxane resin or coating composition, as an intermediate layer or top coat for a metal coil, a coating for a glass substrate, or a coating for a solar backplane.

Another object of the present disclosure is to provide a substrate, comprising a coating composed of the above-mentioned polysiloxane resin or coating composition.

In order to make the objectives, technical features and advantages of the present disclosure more comprehensible, detailed description is provided below with reference to specific embodiments.

### BRIEF DESCRIPTION OF THE DRAWINGS

The invention will be described according to the appended drawings, in which:

FIG. 1 is a schematic diagram of a polysiloxane resin or a coating composition of the present disclosure for use on a substrate.

### DETAILED DESCRIPTION OF THE PRESENT DISCLOSURE

In order to facilitate understanding of the disclosure herein, certain terms are defined below.

The term “non-linear” means branched, reticulated, dendritic, star-shaped, cascadic, or other non-linear shapes.

The term “organic group having an epoxy group” refers to an organic group having one or more epoxy functional groups

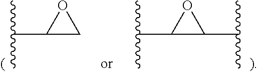

In some embodiments of the present disclosure, it is preferable to use an organic group having a terminal epoxy group.

The term “alkyl” means a saturated straight or branched hydrocarbon group having preferably 1 to 6 carbon atoms, more preferably 1 to 4 carbon atoms, and particularly preferably 1 to 3 carbon atoms. Examples include, but are not limited to, methyl, ethyl, n-propyl and isopropyl.

The term “about” refers to an acceptable deviation of a given value measured by a skilled person, depending, in part, on how the value is measured or determined.

Unless otherwise specified, “molecular weight” or “average molecular weight” herein means weight average molecular weight (Mw) expressed in grams per mole.

Each aspect and embodiment of the present disclosure disclosed herein can be combined individually with all other aspects and embodiments of the present disclosure, including all possible combinations.

I. Polysiloxane Resin

The polysiloxane resin of the present disclosure comprises a reaction product derived from (a) a non-linear polysiloxane oligomer, (b) a linear polysiloxane oligomer, and (c) a siloxane monomer.

(a) Non-Linear Polysiloxane Oligomer (Oligomer A)

The non-linear polysiloxane oligomer of the present disclosure has at least one C₁₋₃alkoxy group or hydroxy group that is bonded to silicon, and can undergo a dehydration-condensation reaction with the (b) linear polysiloxane oligomer and the (c) siloxane monomer, to improve the strength and flexibility of the obtained resin.

According to some embodiments of the present disclosure, the (a) non-linear polysiloxane oligomer has a weight average molecular weight (Mw) of 500-6000, for example, 500, 1000, 1500, 2000, 2500, 3000, 3500, 4000, 5000 or 6000. The polysiloxane resin of the present disclosure has good mechanical properties and flexibility, and the prepared coating can withstand stress caused by volume change without cracking or breaking when returned to room temperature after high temperature baking. When the (a) non-linear polysiloxane oligomer has a weight average molecular weight of less than 500, the toughness and strength of the coating surface are insufficient; and when the weight average molecular weight is above 6000, the coating has poor tolerance to stress and the surface is prone to cracks or fractures. Preferably, the (a) non-linear polysiloxane oligomer has a weight average molecular weight of 1000-5000, and more preferably a weight average molecular weight of 1500-4000. According to some embodiments of the present disclosure, the non-linear polysiloxane oligomer has Formula (I):

(R⁵₃SiO_{1/2})ₓ(R⁶SiO_{3/2})_{y}(R⁷O_{1/2})_{z} (I)

where R⁵ and R⁶ are each independently methyl, phenyl, vinyl, or an organic group having an epoxy group or an acrylic group, and R⁷ is a C₁₋₃ alkyl group (e.g. methyl, ethyl or propyl) or H; each R⁵ may be the same or different, each R⁶ may be the same or different, and each R⁷ may be the same or different; and x□0, y>0, and z>0.

According to some embodiments of the present disclosure, x/y in Formula (I) may be an arbitrary value ranging from 0 to 10, such as 0, 0.005, 0.01, 0.02, 0.05, 0.08, 0.1, 0.15, 0.2, 0.3, 0.4, 0.5, 0.6, 0.7, 0.8, 0.9, 1, 1.1, 1.2, 1.5, 1.8, 2, 2.5, 3, 4, 5, 6, 7, 8, 9 or 10. x/y is preferably from 0.005 to 1.

Specific examples of the organic group having an epoxy group include, but are not limited to,

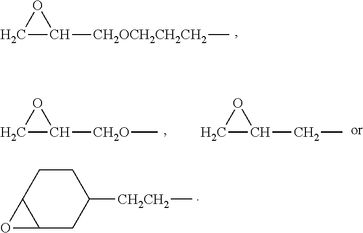

The organic group having an acrylic group means an organic group having acryl (CH₂═CH—C(═O)—) methacryl (CH₂═C(CH₃)—C(═O)—).

According to some embodiments of the present disclosure, the non-linear polysiloxane oligomer of the present disclosure comprises a structural unit derived from a siloxane monomer of Formula (III):

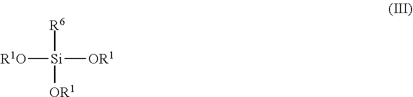

where

each R¹ may be the same or different, and is independently a C₁₋₃ alkyl group, for example, methyl, ethyl or propyl; and

each R⁶ is as defined above.

According to some embodiments of the present disclosure, the siloxane monomer of Formula (III) is selected from the group consisting of methyltrimethoxysilane, methyltriethoxysilane, methyltripropoxysilane, phenyltrimethoxysilane, phenyltriethoxysilane, vinyltrimethoxysilane, vinyltriethoxysilane, γ-glycidoxypropyltrimethoxysilane, γ-glycidoxypropyltriethoxysilane, β-(3,4-epoxycyclohexyl)ethyltrimethoxysilane, β-(3,4-epoxycyclohexyl)ethyltriethoxysilane, and a combination thereof.

The non-linear polysiloxane oligomer of the present disclosure may optionally comprise a unit derived from other monomers. According to some embodiments of the present disclosure, the non-linear polysiloxane oligomer may comprise a structural unit derived from the siloxane monomer of Formula (III) and a siloxane monomer of Formula (IV) or (V):

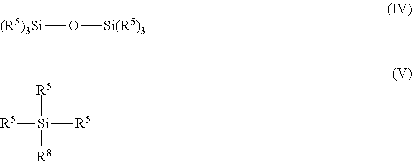

where R⁵ is as defined above, and preferably each R⁵ is methyl; and R⁸ may be the same or different and is each independently a C₁₋₃ alkoxy group or —Cl.

According to some embodiments of the present disclosure, the reaction monomers for the non-linear polysiloxane oligomer also comprise other monomers than the monomers of Formula (III), (IV) or (V).

According to an embodiment of the present disclosure, the siloxane monomer of Formula (IV) is selected from the group consisting of hexamethyldisilane, tetramethyldivinyldisilane, and a combination thereof.

According to an embodiment of the present disclosure, the siloxane monomer of Formula (V) is selected from the group consisting of trimethylmethoxysilane, trimethylethoxysilane, trimethylchlorosilane, chloro(dimethyl)vinylsilane, and a combination thereof.

As mentioned above, x/y in Formula (I) can be an arbitrary value ranging from 0 to 10, where x/y can be construed as the ratio of the siloxane monomer of Formula (IV) or (V) to the siloxane monomer of Formula (III) used in the preparation of the non-linear polysiloxane oligomer. When x/y=0, no siloxane monomer of Formula (IV) or (V) is used in the preparation of the non-linear polysiloxane oligomer. When the siloxane monomer of Formula (IV) or (V) is used, x/y is preferably 0.005 to 1.

As mentioned above, z>0 in Formula (I) means that the non-linear polysiloxane oligomer is not completely capped, and has at least one C₁₋₃ alkoxy group or hydroxy group that is bonded to silicon, which can further undergo a condensation reaction with the (b) linear polysiloxane oligomer and the (c) siloxane monomer, to improve the strength and flexibility of the obtained resin.

According to some embodiments of the present disclosure, the amount of the (a) non-linear polysiloxane oligomer is 0.5 to 15 wt %, for example, 0.5 wt %, 0.75 wt %, 1 wt %, 1.5 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, or 15wt %, and preferably 0.75 to 10 wt %, based on the total weight of the non-linear polysiloxane oligomer, the linear polysiloxane oligomer, and the siloxane monomer.

(b) Linear Polysiloxane Oligomer (Oligomer B)

The linear polysiloxane oligomer of the present disclosure comprises a unit derived from a siloxane monomer of Formula (II):

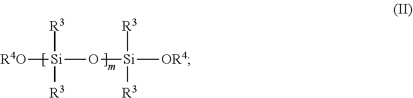

where

each R³ may be the same or different, and is independently methyl or phenyl;

each R⁴ may be the same or different, and is independently H, methyl, or ethyl; and

m is an integer from 2 to 20, for example 2, 3, 4, 5, 6, 8, 10, 12, 14, 16, 18 or 20, and preferably an integer from 5 to 12.

Commercially available products include, for example, Dow Corning® 3074 (molecular weight 1200-1700) or Dow Corning®3037 (molecular weight 700-1500) sold by Cow Corning.

According to some embodiments of the present disclosure, the (b) linear polysiloxane oligomer has a weight average molecular weight (Mw) of 500-5000, for example, 500, 800, 1000, 1200, 1500, 1700, 2000, 3000, 4000, or 5000, preferably a weight average molecular weight of 600-3000, and more preferably a weight average molecular weight of 700-2000.

Generally, the polysiloxane resin is liable to be brittle after film formation. The conventional solution is to add a dialkoxysilane (D-Type siloxane monomer) as a raw material during synthesis. However, it is difficult to control the degree of linear polymerization of the D-Type siloxane monomer, so the improvement is limited. The inventors of the present application find that when the amount of the (b) linear polysiloxane oligomer is 20 to 65 wt %, for example, 20 wt %, 25 wt %, 30 wt %, 35 wt %, 40 wt %, 45 wt %, 50 wt %, 55 wt %, 60 wt % or 65 wt %, based on the total weight of the non-linear polysiloxane oligomer, the linear polysiloxane oligomer and the siloxane monomer, the properties of the coating composition after curing can be adjusted, and better softness is exhibited. According to the present disclosure, if the amount of the linear polysiloxane oligomer is too high (more than 65 wt %), the polysiloxane resin is prone to be too soft, and the hardness is not as good, such that the coating film has insufficient surface strength, and is likely to be scratched. If the amount of the linear polysiloxane oligomer is too low (less than 20 wt %), the coating film is prone to have deteriorated softness, and the defect of brittle coating film cannot be overcome. The aforementioned amount is preferably 25 to 60 wt %, and more preferably 30 to 55 wt %.

(c) Siloxane Monomer

According to some embodiments of the present disclosure, the (c) siloxane monomer has Formula (VI):

(R⁸)ₙSi(OR⁹)₄₋ₙ (VI)

where

R⁸ is each independently H, phenyl, a C₁₋₆ alkyl group, or an organic group having amino, epoxy, vinyl, isocyanate, mercapto or (meth)acryloxy; R⁹ is a C₁₋₃ alkyl group, for example, methyl, ethyl, or propyl; and n is an integer from 0 to 3, for example, 0, 1, 2 or 3.

In a preferred embodiment of the present disclosure, R⁸ is each independently H, methyl, ethyl, vinyl, N-(β-aminoethyl)-γ-aminopropyl, aminopropyl, γ-glycidoxypropyl, β-(3,4-epoxycyclohexyl) ethyl, 3-(methacryloyloxy)propyl or mercaptopropyl, and R⁹ is each independently methyl or ethyl.

According to a preferred embodiment of the present disclosure, the (c) siloxane monomer is selected from the group consisting of trimethylmethoxysilane, trimethylethoxysilane, dimethyldimethoxysilane, dimethyldiethoxysilane, methyltrimethoxysilane, methyltriethoxysilane, methyltripropoxysilane, tetraethoxysilane, vinyltrimethoxysilane, vinyltriethoxysilane, γ-glycidoxypropyltrimethoxysilane, γ-glycidoxypropyltriethoxysilane, γ-glycidoxypropylmethyldimethoxysilane, γ-glycidoxypropylmethyldiethoxysilane, β-(3,4-epoxycyclohexyl)ethyltrimethoxysilane, 3-(methylacryloxy)propyltrimethoxysilane, N-(β-aminoethyl)-γ-aminopropylmethyldimethoxysilane, N-(β-aminoethyl)-γ-aminopropyltrimethoxysilane, γ-aminopropylmethyldiethoxysilane, γ-aminopropyltriethoxysilane, γ-aminopropyltrimethoxysilane, γ-mercaptopropyltrimethoxysilane, and a combination thereof.

According to some embodiments of the present disclosure, the amount of the (c) siloxane monomer is 30 to 75 wt.%, for example, 30 wt %, 35 wt %, 40 wt %, 45 wt %, 50 wt %, 55 wt %, 60 wt %, 65 wt %, 70 wt %, or 75 wt %, preferably 35 to 70 wt %, and more preferably 40 to 65 wt %, based on the total weight of the non-linear polysiloxane oligomer, the linear polysiloxane oligomer, and the siloxane monomer.

(d) Additional Components

According to some embodiments of the present disclosure, silica may be added as an inorganic component in the preparation of the polysiloxane resin and participate in the polymerization reaction. When the amount of silica is 1 to 30 wt % based on the total weight of the non-linear polysiloxane oligomer, the linear polysiloxane oligomer and the siloxane monomer, the hardness of the polysiloxane resin can be further improved. The amount is preferably 5 to 25 wt %, and more preferably 8 to 20 wt %.

Preparation of Polysiloxane Resin

The polysiloxane resin of the present disclosure is made by preparing or obtaining the (a) non-linear polysiloxane oligomer and the (b) linear polysiloxane oligomer respectively, followed by using the (a) non-linear polysiloxane oligomer, the (b) linear polysiloxane oligomer and the (c) siloxane monomer as raw materials for reaction. Without departing from the purpose of the present disclosure, other compounds may be added as raw materials.

The (a) non-linear polysiloxane oligomer and (b) linear polysiloxane oligomer can be synthesized or obtained from commercially available products.

According to some embodiments of the present disclosure, the (a) non-linear polysiloxane oligomer, and the (b) linear polysiloxane oligomer, or the polysiloxane resin of the present disclosure can be synthesized by a sol-gel method. In a typical sol-gel method, the reactants undergo a series of hydrolysis and polymerization reactions to form a colloidal suspension, and the substances therein condense into a new phase, namely a solution containing a solid polymer, i.e. a gel. The properties of the prepared sol-gel depend on the type of raw materials, the type and concentration of the catalyst, pH value, temperature, and the content type and concentration of the solvent.

According to some embodiments of the present disclosure, a solvent may be optionally added in the synthesis steps, including, but not limited to, water, alcohols, ether alcohols or mixtures thereof, such as water, ethylene glycol monobutylether (BCS), ethylene glycol monoethyl ether acetate (CAC), ethylene glycol monoethyl ether (ECS), propylene glycol, mono methyl ether (PGME), propylene glycol monomethyl ether acetate (PMA), propylene glycol methyl ether propionate (PMP), or a mixture of two or more thereof.

Generally, the polysiloxane resin is prone to be brittle after film formation. The conventional solution is to add a dialkoxysilane (D-Type siloxane monomer) as a raw material during synthesis. However, it is difficult to control the degree of linear polymerization of the D-Type siloxane monomer, so the improvement is limited. There are also solutions in which an organic component is mixed in the polysiloxane resin to increase its flexibility; however, the organic component has the disadvantage of inferior heat resistance. In addition, hardness and flexibility are generally contradictory properties. Generally, a resin with a high hardness tends to have poor flexibility and a resin with good flexibility tends to have poor hardness. Although it is known that the properties of the obtained resin can be adjusted by adding a linear monomer during synthesis, it is difficult to predict how to make the resin have both excellent hardness and flexibility.

The inventors of the present application have found that where the pre-synthesized (a) non-linear polysiloxane oligomer and (b) linear polysiloxane oligomer are used in combination with the (c) siloxane monomer as raw materials, the polysiloxane resin prepared with the components (a), (b) and (c) in combination has synergic effects, the coating film formed therewith has high density and high strength, but is not brittle, and can absorb a great amount of stress and withstand volume deformation caused by temperature change, and the coating surface can maintain flatness at a high temperature without cracking. Therefore, the polysiloxane resin of the present disclosure has a wider scope of application. Detailed description will be made with reference to some specific implementations. The component (a) can adjust the structure of the polysiloxane resin so that the polysiloxane resin is tough and rigid, and the coating surface remains flat without cracking. The component (b) imparts softness to the polysiloxane resin, and allows the coating to have bending resistance. The components (a) and (b) allow the coating to have good flexibility, and the component (c) provides the backbone and hardness for the polysiloxane resin. The polysiloxane resin can be further crosslinked if the component (a) contains an organic group having vinyl, epoxy or an acrylic group. By selecting the molecular weights of the oligomers and the content of the three components, the molecular weight and polydispersity index (PDI) of the polysiloxane resin can be adjusted.

The polysiloxane resin of the present disclosure has high hardness, rigidity, flexibility, bending resistance, heat resistance, weather resistance, solvent resistance, and chemical resistance, as well as good storage stability so it can be used as an intermediate layer or a top coat for a metal coil, a coating for a glass substrate, or a coating for a solar backplane. In particular, metal coils may be bent during storage and application. The polysiloxane resin of the present disclosure has good mechanical properties and flexibility, and can withstand the stress generated during bending without cracking or fracturing. In addition, the polysiloxane resin of the present disclosure has excellent heat resistance and flexibility, so it can be used in a high-temperature environment, especially where high temperature resistant coatings are required. For example, the manufacturing process of metal coils often requires a high-temperature environment of 200 to 300° C. The polysiloxane resin of the present disclosure can withstand a high-temperature process.

II. Coating Composition Comprising Polysiloxane Resin

The coating composition of the present disclosure comprises the polysiloxane resin described above. Based on the total weight of the composition, the content of the polysiloxane resin is 1 to 99 wt %, such as 1 wt %, 3 wt %, 5 wt %, 8 wt %, 10 wt %, 15 wt %, 20 wt %, 25 wt %, 30 wt %, 40 wt %, 50 wt %, 60 wt %, 70 wt %, 80 wt %, 90 wt % or 99 wt %, preferably between 5 and 70 wt %, and more preferably between 7 and 50 wt %.

The coating composition of the present disclosure may optionally comprise any additives known to persons having ordinary skill in the art, such as, but not limited to, inorganic particles, colorants, fillers, hardeners, hardening accelerators, ultraviolet absorbers, antistatic agents, matting agents, stabilizers, cooling aids, photocatalysts or anti-floating agents.

According to some embodiments of the present disclosure, the coating composition may optionally comprise inorganic particles. According to a preferred embodiment of the present disclosure, the inorganic particles include titania, zirconia, silica, zinc oxide, strontium titanate, indium tin oxide, antimony tin oxide, lanthanum hexaboride, tungsten oxide, or a combination thereof. The polysiloxane resin can be mixed with the optional inorganic particles in a solvent, and then directly coated on a substrate to form a coating after heat treatment. There are no special limitations for the order and timing of adding the inorganic particles. That is, each component can be mixed with the polysiloxane resin in one portion, in batches or in any order, and can be added during or after the preparation of polysiloxane resin, to impart desired performance to the coating. When added, the content of the inorganic particles is 1 to 70 wt %, and preferably 5 to 60 wt % based on the total weight of the solids content of the coating composition.

When a substrate is exposed to the outdoor environment for a long time, it is easy to accumulate environmental moisture and dirt, resulting in a dirty appearance or poor light utilization. Therefore, according to a preferred embodiment of the present disclosure, inorganic particles having a photocatalytic effect, such as titania, can be added to the coating composition of the present disclosure which is then applied to the surface of a substrate (such as a metal substrate or glass substrate for construction) to form a top coat, thereby providing a self-cleaning function and reducing manual maintenance cost.

According to some embodiments of the present disclosure, the coating composition may optionally comprise photocatalyst particles, such as anatase titania, zinc oxide, tin oxide, zirconia, zinc sulfide, and cadmium sulfide, and the particle size may be from 5 to 100 nm. Where needed, the content of the photocatalyst particles is 5 to 70 wt %, preferably 10 to 60 wt %, and more preferably 20 to 40 wt %, based on the total weight of the solids content in the coating composition.

The solvents that can be used in the coating composition of the present disclosure are not particularly limited in principle, and can be any suitable solvents known to persons having ordinary skill in art, such as, but not limited to, water, alcohols, benzenes, ethers, esters, ketones or combinations thereof. Non-limiting examples of alcohol solvents include methanol, ethanol, propanol, butanol, isobutanol, or the like. Non-limiting examples of benzene solvents include benzene, toluene, o-xylene, m-xylene, p-xylene, trimethylbenzene, styrene or the like. Non-limiting examples of ether solvents include propyl ether, butyl ether, ethylene glycol methyl ether, propylene glycol methyl ether, ethylene glycol methyl ether acetate, propylene glycol methyl ether acetate, diethylene glycol butyl ether acetate or the like. Non-limiting examples of ester solvents include, for example, ethyl acetate, butyl acetate, diethyl carbonate, ethyl formate, methyl acetate, ethoxy ethyl acetate, ethoxy propyl acetate or monomethyl ether propylene glycol ester or the like. Non-limiting examples of ketone solvents include acetone, methyl ethyl ketone, isobutyl ketone or the like.

In conventional methods for preparing a coating, the physical vapor deposition has the disadvantage of requiring expensive equipment; and the chemical vapor deposition has the advantages of being fast and cheap, but the formed film has poor abrasion resistance. In contrast, the polysiloxane resin in the coating composition of the present disclosure is prepared through a sol-gel method, and the obtained coating composition can be directly applied on a substrate. Therefore, the coating composition is low in cost, can be produced quickly, and is suitable for continuous production. It is also relatively simple to replace the chemical precursor. The coating method used in the present disclosure may be any method known to persons having ordinary skill in the art, such as, but not limited to: knife coating, roller coating, micro gravure printing, flow coating, dip coating, spray coating, slot die coating, spin coating and curtain coating. According to some embodiments of the present disclosure, the coating composition can be applied on a substrate by roller coating or spray coating. According to some embodiments of the present disclosure with the use of the coating composition according to the present disclosure, the effect of simultaneous double-sided coating of the substrate can be achieved by dipping and lifting method.

III. Application of Polysiloxane Resin and/or Coating Composition

According to some embodiments of the present disclosure, the polysiloxane resin or coating composition of the present disclosure can be coated on a substrate for the purpose of protection, scratch resistance, impact resistance, weather resistance, reflection, heat insulation or cleaning. The substrate is, for example, but not limited to, a metal substrate, a plastic substrate, a glass substrate, or a solar backplane. The type of metal substrate is not particularly limited, and may be, for example, steel, aluminum, or alloy materials. The type of the plastic substrate is not particularly limited, and may be selected from the group consisting of, for example, but not limited to, a polyester resin such as polyethylene terephthalate (PET) or polyethylene naphthalate (PEN), a polyacrylate resin such as polymethyl methacrylate (PMMA), a polyolefin resin such as polyethylene (PE) or polypropylene (PP), a polycycloolefin resin, a polyimide resin, a polycarbonate resin, a polyurethane resin, triacetyl cellulose (TAC), polylactic acid, polyvinyl chloride, and a combination thereof. The plastic substrate is preferably selected from a polyester resin, a polycarbonate resin, and combinations thereof, and more preferably polyethylene terephthalate.

The polysiloxane resin of the present disclosure has advantageous properties in terms of hardness, rigidity, flexibility bending resistance, weather resistance, solvent resistance, and heat resistance, and can be prepared, together with various additives when needed, into a coating composition. The polysiloxane resin or coating composition of the present disclosure is applicable to various uses, especially those that require more than one of the above properties at the same time, and can be used as an intermediate layer or a top coat for a metal coil, a coating for a glass substrate, or a coating for a solar backplane.

According to some embodiments of the present disclosure, the coating composition of the present disclosure can be used as a top coat or an intermediate layer for a metal coil. The substrate for the metal coil may be, for example, but not limited to, a metal substrate of steel, aluminum or an alloy. As mentioned above, metal coils may be bent during storage and application. In addition, if the top coat contains photocatalyst particles (such as anatase titania), the oxidation characteristics of the photocatalyst tend to cause the underlying coating (such as a color paint layer or a primer layer) to deteriorate. This will cause the coating to peel off, affecting the color rendering effect and the efficacy of the photocatalyst. The common solution to this problem is to interpose a photocatalyst-free intermediate layer between the photocatalyst layer (i.e. the top coat) and the underlying coating. In addition to protecting the underlying coating, the intermediate layer has to provide good adhesion between the photocatalyst layer and the underlying coating, and reduce the interfacial stress caused by bending between different layers. However, if the resins used in the photocatalyst layer and the intermediate layer are different, the processing complexity will be increased. The polysiloxane resin of the present disclosure has advantageous properties in terms of hardness, rigidity, flexibility, bending resistance and heat resistance. Therefore, the coating composition prepared with the polysiloxane resin of the present disclosure can be directly used to form a photocatalyst top coat serving as a surface coating, to achieve the beneficial effects of self-cleaning of the surface of the metal coil and reduced cost of manual maintenance. The coating composition can also be used as an intermediate layer to effectively extend the life of a coating such as the color paint layer or the primer layer and maintain the efficacy of the photocatalyst.

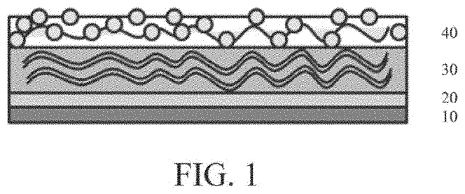

According to some embodiments of the present disclosure, the coating composition of the present disclosure can be used as a top coat or an intermediate layer. As shown in FIG. 1, an intermediate layer 30 and a top coat 40 are sequentially applied on a substrate 10, and a silicone modified polyester (SMP) layer 20 is optionally coated on the substrate before the intermediate layer 30 is applied. The intermediate layer 30 and the top coat 40 can be formed with the same or different polysiloxane resins. The intermediate layer 30 can effectively absorb the interfacial stress caused by temperature difference during processing. Unlike the intermediate layer 30, the top coat 40 is a surface protection coating, and other additives, for example a photocatalyst such as titania, can be optionally added to form a photocatalyst top coat. According to a preferred embodiment of the present disclosure, the substrate 10 may be a metal substrate or a glass substrate, and the intermediate layer 30 and the top coat 40 can be formed with the same polysiloxane resin.

As for the glass substrate, it has the disadvantages of fragility and poor impact resistance. Accordingly, the glass substrate is easily damaged and cracked under impact, and the resulting glass debris may scatter around. The coating composition of the present disclosure can be applied to a glass substrate to form a tempered coating for glass. Due to its flexibility, it can provide sufficient protection and reduce the glass debris. In addition, with the use of the coating composition of the present disclosure, the effect of simultaneous double-sided coating of the substrate can be achieved by the dipping and lifting method as described above, so the coating composition of the present disclosure has the advantage of being easy to process.

According to some embodiments of the present disclosure, the coating composition of the present disclosure can be used for a solar backplane to protect and support the solar cell, and provide good insulativity, water resistance, weather resistance, and aging resistance. In addition, a substance that can reflect light (such as titanium oxide, TiO₂) may be optionally added into the coating composition of the present disclosure to improve the light reflection rate, so as to improve the sunlight utilization rate.

### EXAMPLES

The examples below are provided for further illustrating the present disclosure, instead of limiting the scope of present disclosure. Modifications and changes readily made by any persons having ordinary skill in the art are contemplated in the disclosure of the specification and the scope of the claims.

(a) Preparation of Non-Linear Polysiloxane Oligomer (Oligomer A)

Synthesis of TE-24

1652 parts by weight of phenyltrimethoxysilane, 4458 parts by weight of methyltriethoxysilane, 687 parts by weight of water, and 6120 parts by weight of ethyl acetate were stirred in a reactor, and then a mixed aqueous solution of 1067 parts by weight of water and 77 parts by weight of hydrochloric acid (concentration 36.5 wt %) was added dropwise. After that, the temperature was raised to 65° C. and the reaction was continued at constant temperature for 1 hr. Then, 500 parts by weight of γ-glycidoxypropyltrimethoxysilane was added dropwise, and the solution was heated to 77° C. and reacted for 4 hrs at constant temperature. The reaction solution was then cooled to room temperature, diluted with ethyl acetate and water, and adjusted to pH 7 with sodium carbonate (tested with litmus paper). Water was added to the solution, which was stirred and allowed to stand for layer separation. The aqueous layer was removed and the process was repeated three times. Finally, anhydrous magnesium sulfate was added to the solution and stirred until dispersed, and the magnesium sulfate was removed by filtration through filter paper, to obtain a solution in ethyl acetate of TE-24 polysiloxane oligomer A with a solids content of about 50 wt % and a molecular weight of about 1558.

Synthesis of OT-24

537 parts by weight of phenyltrimethoxysilane, 1455 parts by weight of methyltriethoxysilane, 223 parts by weight of water, and 2001 parts by weight of ethyl acetate were stirred in a reactor, and then a mixed aqueous solution of 27 parts by weight of water and 2 parts by weight of hydrochloric acid (concentration 36.5 wt %) was added dropwise. After that, the temperature was raised to 77° C. and the reaction was continued at constant temperature for 4 hrs. During the reaction, the alcohol and ester solvents were distilled off. The reaction solution was then cooled to room temperature, diluted with ethyl acetate and water, and adjusted to pH 7 with sodium carbonate (tested with litmus paper). Water was added to the solution, which was stirred and allowed to stand for layer separation. The aqueous layer was removed and the process was repeated three times. Finally, anhydrous magnesium sulfate was added to the solution and stirred until dispersed, and the magnesium sulfate was removed by filtration through filter paper, to obtain a solution in ethyl acetate of OT-24 polysiloxane oligomer A with a solids content of about 50 wt % and a molecular weight of about 10292.

Synthesis of OTM-24

496 parts by weight of phenyltrimethoxysilane, 1337 parts by weight of methyltriethoxysilane, 206 parts by weight of water, and 1836 parts by weight of ethyl acetate were stirred in a reactor, and then a mixed aqueous solution of 320 parts by weight of water and 23 parts by weight of hydrochloric acid (concentration 36.5 wt %) was added dropwise, and the solution was heated to 65° C. and reacted for 1 hr at constant temperature. 52 parts by weight of hexamethyldisilane was added dropwise, and the solution was heated to 77° C. and reacted at constant temperature for 4 hrs. During the reaction, the alcohol and ester solvents were distilled off. The reaction solution was then cooled to room temperature, diluted with ethyl acetate and water, and adjusted to pH 7 with sodium carbonate (tested with litmus paper). Water was added to the solution, which was stirred and allowed to stand for layer separation. The aqueous layer was removed and the process was repeated three times. Finally, anhydrous magnesium sulfate was added to the solution and stirred until dispersed, and the magnesium sulfate was removed by filtration through filter paper, to obtain a solution in ethyl acetate of OTM-24 polysiloxane oligomer A with a solids content of about 50 wt % and a molecular weight of about 6484.

Synthesis of TM-03

380 parts by weight of methyltriethoxysilane, 29 parts by weight of hexamethyldisilane, 152 parts by weight of water, 152 parts by weight of ethanol, and 1369 parts by weight of ethyl acetate were stirred in a reactor, and then a pre-mixed aqueous solution of 190 parts by weight of water and 18 parts by weight of hydrochloric acid (concentration 36.5 wt %) was added dropwise. After that, the temperature was raised to 77° C. and the reaction was continued at constant temperature for 4 hrs. During the reaction, the alcohol and ester solvents were distilled off. The reaction solution was then cooled to room temperature, diluted with ethyl acetate and water, and adjusted to pH 7 with sodium carbonate (tested with litmus paper). Water was added to the solution, which was stirred and allowed to stand for layer separation. The aqueous layer was removed and the process was repeated three times. Finally, anhydrous magnesium sulfate was added to the solution and stirred until dispersed, and the magnesium sulfate was removed by filtration through filter paper, to obtain a solution in ethyl acetate of TM-03 polysiloxane oligomer A with a solids content of about 50 wt % and a molecular weight of about 3103.

<Preparation of Polysiloxane Resin>

Oligomer A, Oligomer B (Dow Corning 3074), a siloxane monomer and propylene glycol methyl ether acetate (PMA) were fed to a glass reactor according to the amounts (in grams) shown in Tables 1 and 2. A silica solution (Nissan Snowtex-o with a solids content of 20 wt %), citric acid and water were added to the reactor, stirred, heated to 80° C. and reacted at constant temperature for 6 hrs. After that, ethylene glycol monobutyl ether (BCS) was added, reacted at 80° C. for 2 hrs, followed by cooling to room temperature. Thereby, the products in Examples 1-7 and Comparative Examples 1-9 were prepared.

TABLE 1

| | | Example 1 | Example 2 | Example 3 | Example 4 | Example 5 | Example 6 | Example 7 |
|---|---|---|---|---|---|---|---|---|
| Siloxane | Tetraethoxysilane | 24.3 | 24.3 | 24.3 | 24.3 | 24.3 | 24.3 | 48.6 |
| monomer | Methyltrimethoxysilane | 85.1 | 85.1 | 85.1 | 85.1 | 85.1 | 85.1 | 106.4 |
| | γ-glycidoxypropyltrimethoxysilane | 54.3 | 54.3 | 54.3 | 54.3 | 54.3 | 54.3 | 54.3 |
| | Total weight of siloxane monomer | 163.7 | 163.7 | 163.7 | 163.7 | 163.7 | 163.7 | 209.3 |
| Oligomer B | Dow Corning 3074 | 193.9 | 193.9 | 193.9 | 193.9 | 193.9 | 162 | 113.4 |
| Oligimer A | OT-24 solution (50 wt %) | 0 | 0 | 0 | 0 | 0 | 0 | 0 |
| | OTM-24 solution (50 wt %) | 0 | 0 | 0 | 0 | 0 | 0 | 0 |
| | TE-24 solution (50 wt %) | 6.8 | 17 | 34 | 54.4 | 74.8 | 0 | 8.5 |
| | TM-03 solution (50 wt %) | 0 | 0 | 0 | 0 | 0 | 11.6 | 0 |
| | Total weight of Oligomer A | 3.4 | 8.5 | 17 | 27.2 | 37.4 | 5.8 | 4.25 |

| | | | | | | | |
|---|---|---|---|---|---|---|---|
| PMA | 56.5 | 56.5 | 56.5 | 56.5 | 56.5 | 91.3 | 135 |
| Critic acid | 3.15 | 3.15 | 3.15 | 3.15 | 3.15 | 3.15 | 3.15 |
| Silica solution (20 wt %) | 240.5 | 240.5 | 240.5 | 240.5 | 240.5 | 240.5 | 240.5 |
| H₂O | 34.02 | 34.02 | 34.02 | 34.02 | 34.02 | 29.02 | 0 |
| BCS | 229.3 | 229.3 | 229.3 | 229.3 | 229.3 | 100 | 159.3 |
| Total weight | 927.87 | 938.07 | 955.07 | 975.47 | 995.87 | 801.27 | 869.15 |
| Oligomer A + Oligomer B + siloxane monomer | 361 | 366.1 | 374.6 | 384.8 | 395 | 331.5 | 326.95 |
| Proportion of Oligomer A * (wt %) | 0.94% | 2.32% | 4.54% | 7.07% | 9.47% | 1.75% | 1.30% |
| Proportion of Oligomer B * (wt %) | 53.71% | 52.96% | 51.76% | 50.39% | 49.09% | 48.87% | 34.68% |
| Proportion of siloxane monomer * (wt %) | 45.35% | 44.71% | 43.70% | 42.54% | 41.44% | 49.38% | 64.02% |

*based on the total weight of Oligomer A (non-linear polysiloxane oligomer) + Oligomer B (linear polysiloxane oligomer) + siloxane monomer

TABLE 2

| | | Comparative | Comparative | Comparative | Comparative | Comparative |
|---|---|---|---|---|---|---|
| | | Example 1 | Example 2 | Example 3 | Example 4 | Example 5 |
| Siloxane | Tetraethoxysilane | 48.6 | 48.6 | 24.3 | 24.3 | 24.3 |
| monomer | Methyltrimethoxysilane | 106.4 | 106.4 | 85.1 | 85.1 | 85.1 |
| | γ-glycidoxypropyltrimethoxysilane | 54.3 | 54.3 | 54.3 | 54.3 | 54.3 |
| | Total weight of siloxane monomer | 209.3 | 209.3 | 163.7 | 163.7 | 163.7 |
| Oligomer B | Dow Corning 3074 | 113.4 | 113.4 | 193.9 | 0.00% | 193.9 |
| Oligomer A | OT-24 solution (50 wt %) | 8.5 | 0 | 0 | 0 | 0 |
| | OTM-24 solution (50 wt %) | 0 | 8.5 | 0 | 0 | 0 |
| | TE-24 solution (50 wt %) | 0 | 0 | 1.785 | 0 | 0.00% |
| | TM-03 solution (50 wt %) | 0 | 0 | 0 | 0 | 0 |
| | Total weight of Oligomer A | 4.25 | 4.25 | 0.8925 | 0 | 0 |

| | | | | | |
|---|---|---|---|---|---|
| PMA | 135 | 135 | 56.5 | 56.5 | 56.5 |
| Critic acid | 3.15 | 3.15 | 3.15 | 3.15 | 3.15 |
| Silica solution (20 wt %) | 240.5 | 240.5 | 240.5 | 120 | 240.5 |
| H₂O | 0 | 0 | 34.02 | 34.02 | 34.02 |
| BCS | 159.3 | 159.3 | 229.3 | 229 | 229.3 |
| Total weight | 869.15 | 869.15 | 922.855 | 606.67 | 921.07 |
| Oligomer A + Oligomer B + siloxane monomer | 326.95 | 326.95 | 358.493 | 163.7 | 357.6 |
| Proportion of Oligomer A * (wt %) | 1.30% | 1.30% | 0.25% | 0.00% | 0.00% |
| Proportion of Oligomer B * (wt %) | 34.68% | 34.68% | 54.09% | 0.00% | 54.22% |
| Proportion of siloxane monomer * (wt %) | 64.02% | 64.02% | 45.66% | 100.00% | 45.78% |

| | | Comparative | Comparative | Comparative | Comparative |
|---|---|---|---|---|---|
| | | Example 6 | Example 7 | Example 8 | Example 9 |
| Siloxane | Tetraethoxysilane | 24.3 | 9.4 | 47.65 | 15.04 |
| monomer | Methyltrimethoxysilane | 85.1 | 32.97 | 166.87 | 52.7 |
| | γ-glycidoxypropyltrimethoxysilane | 54.3 | 21.04 | 47.6 | 33.6 |
| | Total weight of siloxane monomer | 163.7 | 63.41 | 262.12 | 101.34 |
| Oligomer B | Dow Corning 3074 | 0.00% | 162 | 36.6 | 256.3 |
| Oligomer A | OT-24 solution (50 wt %) | 0 | 0 | 0 | 0 |
| | OTM-24 solution (50 wt %) | 0 | 0 | 0 | 0 |
| | TE-24 solution (50 wt %) | 17 | 106.08 | 17 | 17 |
| | TM-03 solution (50 wt %) | 0 | 0 | 0 | 0 |
| | Total weight of Oligomer A | 8.5 | 53.04 | 8.5 | 8.5 |

| | | | | |
|---|---|---|---|---|
| PMA | 56.5 | 91.3 | 56.5 | 56.5 |
| Critic acid | 3.15 | 3.15 | 3.15 | 3.15 |
| Silica solution (20 wt %) | 120 | 240.5 | 240.5 | 240.5 |
| H₂O | 34.02 | 29.62 | 34.02 | 34.02 |
| BCS | 229.3 | 100 | 229.3 | 229.3 |
| Total weight | 623.67 | 795.46 | 879.19 | 938.11 |
| Oligomer A + Oligomer B + siloxane monomer | 172.2 | 278.45 | 307.2 | 366.14 |
| Proportion of Oligomer A * (wt %) | 4.94% | 19% | 2.7% | 2.3% |
| Proportion of Oligomer B * (wt %) | 0.00% | 58.2% | 12% | 70% |
| Proportion of siloxane monomer * (wt %) | 95.06% | 22.7% | 85.3% | 27.7% |

based on the total weight of Oligomer A (non-linear polysiloxane oligomer) + Oligomer B (linear polysiloxane oligomer) + siloxane monomer

<Test of Physical Properties>

The resins prepared in the above examples and comparative examples were diluted with PMA to a solids content of about 15 wt %, and coated on a tin plate (7*14 cm) polished with sandpaper at a thickness of about 18 μm using coating rod No. 8, and baked at 200° C. for 30 min to form a coating with a thickness of about 2.7 μm.

Various tests were performed, including flexibility, transparency, chemical resistance (solvent resistance, acid and alkali resistance), adhesion, impact test and pencil hardness. Details of each test are as follows:

Solvent resistance: The coating was wiped back and forth with alcohol, xylene and butanone (methyl ethyl ketone) in a wet state (where 1 round trip is counted as 1 time) to observe whether the coating is damaged every 50 times. The wipe times before damage occurred were recorded.

Acid resistance: A spot test was performed with a 5 wt % hydrochloric acid solution in a wet state to observe with the naked eye whether the coating is damaged. The symbol “∘” indicates that there is no difference between the color of the coating in the test area and the surrounding non-test area, “Δ” indicates that the coating in the test area has a slight color change and is different in color from the surrounding non-test area, and “X” indicates that the coating in the test area is completely etched, and the substrate is directly exposed.

Alkali resistance: A spot test was performed with a 5 wt % sodium hydroxide solution in a wet state to observe with the naked eye whether the coating is damaged. The determination criteria are the same as those for acid resistance.

Adhesion: 100 grid test with 3M Scotch 600 adhesive tape was performed.

Pencil hardness: A Mitsubishi pencil for standard hardness test under a load of 1 kg was used to test the hardness of the coating.

Impart resistance test: An impact tester (made by Jinliang Industrial Co., Ltd.) was used, in which an impact head (with a diameter of 3/16″) at the bottom of an impact hammer was brought into contact with the substrate, and a drop hammer weighing 1 kg was set 0.5 m above the impact hammer. The drop hammer was allowed to free fall to hit the impact hammer in order for the impact head to hit the substrate. The side of the substrate coated with the coating is regarded as the front side, and the uncoated side is regarded as the back side. After the impact, the coating was visually observed for damage.

T-bend test: The coating composition prepared above was coated on an iron sheet, and cured by reaction for 30 min at a temperature of 180° C. The thickness of the coating film was about 20 μm. The iron sheet coated with the coating composition was T-bent according to the test method of JIS-H4001-67.45. The first bend represents 0T, the second bend represents 1T, and so on. The lower the T is, the better the flexibility will be.

Surface cracking upon high-temperature baking: The resins prepared in the examples and comparative examples were diluted with PMA to a solids content of about 15 wt %, coated on a tin plate (7*14 cm) polished with sandpaper at a thickness of about 18 μm using coating rod No. 8, and baked at 300° C. for 45 sec. After being cooled to room temperature, the coating surface was inspected for cracks at a magnification of 15×. The symbol “∘” indicates that no cracks are observed at a magnification of 15×. The symbol “Δ” indicates that no cracks are observed with the naked eye, but cracks are observed at a magnification of 15×, and “X” indicates that cracks are observed with the naked eye.

The results of each test are shown in Tables 3 and 4.

TABLE 3

| Physical property | Example 1 | Example 2 | Example 3 | Example 4 | Example 5 | Example 6 | Example 7 |
|---|---|---|---|---|---|---|---|
| Film thickness (μm) | about 2.7 μm | about 2.7 μm | about 2.7 μm | about 2.7 μm | about 2.7 μm | about 2 7 μm | about 2.7 μm |
| Pencil hardness | >4H | >4H | 8H | 8H | 7H | >4H | 4H |
| Adhesion (100 grid test) | 100/100 | 100/100 | 100/100 | 100/100 | 100/100 | 100/100 | 100/100 |
| Acid resistance (HCl) (5 wt %), spot test | ∘ | ∘ | ∘ | ∘ | ∘ | ∘ | ∘ |
| Alkali resistamce (NaOH) (5 wt %), spot test | ∘ | ∘ | ∘ | ∘ | ∘ | ∘ | Δ |
| Solvent resistance (number of passes | | | | | | | |
| when wiped back and forth) | | | | | | | |
| Ethanol | 300 | 300 | 300 | 300 | 300 | 250 | 300 |
| Xylene | 300 | 300 | 200 | 200 | 200 | 100 | 300 |
| Butanone | 100 | 300 | 200 | 250 | 200 | 150 | 300 |
| Impact resistance (1 kg/0.5 m) | | | | | | | |
| Front face | ( 3/16″) pass | ( 3/16″) pass | ( 3/16″) pass | ( 3/16″) pass | ( 3/16″) pass | ( 3/16″) pass | ( 3/16″) pass |
| Back face | ( 3/16″) pass | ( 3/16″) pass | ( 3/16″) pass | ( 3/16″) pass | ( 3/16″) pass | ( 3/16″) pass | ( 3/16″) pass |
| T-bend | 0-1T | 0-1T | 0-1T | 0-1T | 0-1T | 0-1T | 0-1T |
| Surface cracking upon high-temperature | Δ | ∘ | ∘ | ∘ | ∘ | ∘ | ∘ |
| baking | | | | | | | |

TABLE 4

| | Comparative | Comparative | Comparative | Comparative | Comparative |
|---|---|---|---|---|---|
| Physical property | Example 1 | Example 2 | Example 3 | Example 4 | Example 5 |
| Film thickness (μm) | about 2.7 μm | about 2.7 μm | about 2.7 μm | about 2.7 μm | about 2.7 μm |
| Pencil hardness | >4H | >4H | >4H | >4H | 3H |
| Adhesion (100 grid test) | 100/100 | 100/100 | 100/100 | 100/100 | 100/100 |
| Acid resistance (HCl) (5 wt %), spot test | Δ | Δ | Δ | x | ∘ |
| Alkali resistance (NaOH) (5 wt %), spot test | Δ | Δ | ∘ | x | ∘ |
| Solvent resistance (number of passes | | | | | |
| when wiped back and forth) | | | | | |
| Ethanol | 300 | 300 | 200 | 300 | 200 |
| Xylene | 300 | 300 | 250 | 300 | 250 |
| Butanone | 300 | 300 | 100 | 300 | 50 |
| Impact resistnce (1 kg/0.5 m) | | | | | |
| Front face | ( 3/16″) pass | ( 3/16″) pass | ( 3/16″) pass | ( 3/16″) pass | ( 3/16″) pass |
| Back face | ( 3/16″) pass | ( 3/16″) pass | ( 3/16″) pass | ( 3/16″) pass | ( 3/16″) pass |
| T-bend | 0-1T | 0-1T | 0-1T | 1-2T | 0-1T |
| Surface cracking upon high-temperature | x | x | x | x | x |
| baking | | | | | |

| | Comparative | Comparative | Comparative | Comparative |
|---|---|---|---|---|
| Physical property | Example 6 | Example 7 | Example 8 | Example 9 |
| Film thickness (μm) | about 2.7 μm | about 2.7 μm | about 2.7 μm | about 2.7 μm |
| Pencil hardness | >5H | >4H | >4H | 3H |
| Adhesion (100 grid test) | 100/100 | 100/100 | 100/100 | 100/100 |
| Acid resistance (HCl) (5 wt %), spot test | Δ | ∘ | ∘ | ∘ |
| Alkali resistance (NaOH) (5 wt %), spot test | Δ | x | x | ∘ |
| Solvent resistance (number of passes | | | | |
| when wiped back and forth) | | | | |
| Ethanol | 300 | 300 | 300 | 300 |
| Xylene | 300 | 50 | 300 | 100 |
| Butanone | 250 | 50 | 300 | 200 |
| Impact resistnce (1 kg/0.5 m) | | | | |
| Front face | ( 3/16″) pass | ( 3/16″) pass | ( 3/16″) pass | ( 3/16″) pass |
| Back face | ( 3/16″) pass | ( 3/16″) pass | ( 3/16″) pass | ( 3/16″) pass |
| T-bend | 1-2T | 0-1T | 1-2T | 0-1T |
| Surface cracking upon high-temperature | x | x | x | x |
| baking | | | | |

From the results it can be seen that in Examples 1 to 7 (a) a non-linear polysiloxane oligomer, having a molecular weight of 500-6000, (b) a linear polysiloxane oligomer, and (c) a siloxane monomer were used. The prepared resins slid good physical properties, such as hardness, adhesion, acid resistance, alkali resistance, solvent resistance, impact resistance, flexibility, high-temperature baking resistance, etc.

In comparison, in Comparative Example 1, OT-24 with a molecular weight of about 10292 was used as the (a) non-linear polysiloxane oligomer; in Comparative Example 2, OTM-24 with a molecular weight of about 6484 was used as the (a) non-linear polysiloxane oligomer; in Comparative Example 3, a low amount of the (a) non-linear polysiloxane oligomer was used; in Comparative Example 4, no (a) non-linear polysiloxane oligomer or (b) linear polysiloxane oligomer was used; in Comparative Example 5, no (a) non-linear polysiloxane oligomer was used; in Comparative Example 6, no (b) linear polysiloxane oligomer was used; in Comparative Example 7, a high amount of (a) non-linear polysiloxane oligomer was used; in Comparative Example 8, a low amount of (b) linear polysiloxane oligomer was used; and in Comparative Example 9, a high amount of (b) linear polysiloxane oligomer was used. The physical properties obtained in the above comparative examples were poor.

The above-described embodiments of the present disclosure are intended to be illustrative only. Numerous alternative embodiments may be devised by persons having ordinary skill in the art without departing from the scope of the following claims.

What is claimed is:

1. A polysiloxane resin, comprising a reaction product of the following:
(a) a non-linear polysiloxane oligomer having a C₁₋₃ alkoxy group or a hydroxy group, and a weight average molecular weight of about 500-6000;
(b) a linear polysiloxane oligomer of Formula (II): 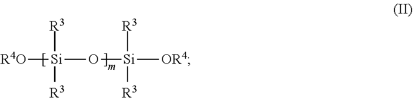
and
(c) a siloxane monomer,
wherein each R³ may be the same or different and is independently methyl or phenyl; each R⁴ may be the same or different and is independently H, methyl or ethyl; and m is an integer from 2 to 20.

2. The polysiloxane resin according to claim 1, wherein the (b) linear polysiloxane oligomer has a weight average molecular weight of 500-5000.

3. The polysiloxane resin according to claim 1, wherein the (a) non-linear polysiloxane oligomer has Formula (I):
(R⁵₃SiO_{1/2})ₓ(R⁶SiO_{3/2})_{y}(R⁷O_{1/2})_{z} (I)
wherein R⁵ and R⁶ are each independently methyl, phenyl, vinyl, or a monovalent organic group having an epoxy group or an acrylic group, and R⁷ is a C₁₋₃ alkyl group or H; each R⁵ may be the same or different, each R⁶ may be the same or different, and each R⁷ may be the same or different; x□0, y>0, and z>0; and x/y is an arbitrary value ranging from 0 to 10.

4. The polysiloxane resin according to claim 1, wherein the (a) non-linear polysiloxane oligomer comprises a structural unit derived from a siloxane monomer of Formula (III): 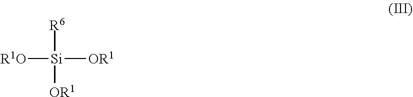
wherein each R¹ may be the same or different, and is independently a C₁₋₃ alkyl group; each R⁶ may be the same or different, and is independently methyl, phenyl, vinyl, or an organic group having an epoxy group or an acrylic group.

5. The polysiloxane resin according to claim 1, wherein the (a) non-linear polysiloxane oligomer comprises a structural unit derived from the siloxane monomer of Formula (III) and a siloxane monomer of Formula (IV) or (V): 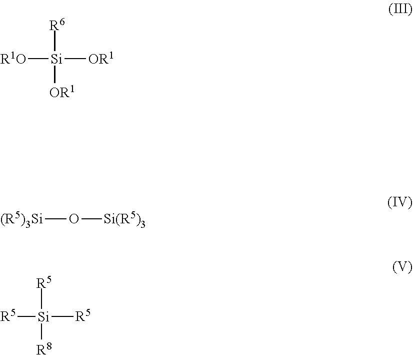
wherein
each R¹ may be the same or different, and is independently a C₁₋₃ alkyl group;
each R⁶ may be the same or different, and is independently methyl, phenyl, or an organic group having an epoxy group or an acrylic group;
each R⁵ may be the same or different, and is independently methyl, phenyl, vinyl, or an organic group having an epoxy group or an acrylic group; and
each R⁸ may be the same or different, and is independently a C₁₋₃ alkoxy group or —Cl.

6. The polysiloxane resin according to claim 1, wherein the amount of the (a) non-linear polysiloxane oligomer is 0.5 to 15 wt % based on the total weight of the non-linear polysiloxane oligomer, the linear polysiloxane oligomer and the siloxane monomer.

7. The polysiloxane resin according to claim 1, wherein the amount of the (b) linear polysiloxane oligomer is 20 to 65 wt % based on the total weight of the non-linear polysiloxane oligomer the linear polysiloxane oligomer and the siloxane monomer.

8. The polysiloxane resin according to claim 1, wherein the amount of the (c) siloxane monomer is 30 to 75 wt % based on the total weight of the non-linear polysiloxane oligomer, the linear polysiloxane oligomer and the siloxane monomer.

9. The polysiloxane resin according to claim 1, wherein the (c) siloxane monomer is selected from the group consisting of trimethylmethoxysilane, trimethylethoxysilane, dimethyldimethoxysilane, dimethyldiethoxysilane, methyltrimethoxysilane, methyltriethoxysilane, methyltripropoxysilane, tetraethoxysilane, vinyltrimethoxysilane, vinyltriethoxysilane, γ-glycidoxypropyltrimethoxysilane, γ-glycidoxypropyltriethoxysilane, γ-glycidoxypropylmethyldimethoxysilane, γ-glycidoxypropylmethyldiethoxysilane, β-(3,4-epoxycyclohexyl)ethyltrimethoxysilane, 3-(methylacryloxy)propyltrimethoxysilane, N-(β-aminoethyl)-γ-aminopropylmethyldimethoxysilane, N-(β-aminoethyl)-γ-aminopropyltrimethoxysilane, γ-aminopropylmethyldiethoxysilane γ-aminopropyltriethoxysilane, γ-aminopropyltrimethoxysilane, and γ-mercaptopropyltrimethoxysilane, and a combination thereof.

10. A coating composition, comprising a polysiloxane resin according to claim 1.

11. The coating composition according to claim 10, further comprising inorganic particles.

12. A method comprising use of a polysiloxane resin according to claim 1 as an intermediate layer or a top coat for a metal coil, a coating for a glass substrate, or a coating for a solar backplane.

13. A substrate comprising a coating formed with a polysiloxane resin according to claim 1, wherein the substrate is a metal substrate, a glass substrate or a solar backplane.
